(19) United States
(12) Patent Application Publication
(10) Pub. No.: US 2026/0357940 A1
(43) Pub. Date: Nov. 12, 2026

(54) A TRACTOR FOR PROPELLING AN APPARATUS INSIDE A CYLINDRICAL BODY

(71) Applicant: PIPESNAKE AS, Stavanger (NO)

(72) Inventor: Tomas SOLVIG, SOLA (NO)

(21) Appl. No.: 19/125,088

(22) PCT Filed: Nov. 8, 2023
(86) PCT No.: PCT/EP2023/081084

§ 371 Date: Apr. 28, 2025

(30) Foreign Application Priority Data
Nov. 9, 2022 (NO) 20221204
Nov. 15, 2022 (NO) 20221225

(51) Int. Cl. F16L 55/38; F16K 17/02

(52) U.S. Cl. CPC F16L 55/38; F16K 17/02

(57) ABSTRACT

The present disclosure relates to a tractor (10) for propelling an apparatus (104) inside a cylindrical body (60). The tractor (10) comprises a fluid motor (14). The tractor (10) further comprises a fluid guide conduit (15) adapted to guide fluid to the fluid motor (14). The tractor (10) further comprises a set of drive portions (20) comprising at least one drive portion (22) wherein each drive portion (22) in the set of drive portions (20) comprises:—a drive shaft (26) connected to the fluid motor (14) whereby the drive shaft (26) is adapted to be rotated around an axis of rotation (30) of the drive shaft (26),—a set of propulsion members (34) comprising at least one propulsion member (12), preferably two or more propulsion members, each propulsion member (12) in the set of propulsion members (34) being rotationally fixed to the drive shaft (26);—a fluid actuated control assembly (38) adapted to control a largest distance (54), in a direction perpendicular to the axis of rotation (30) of the drive shaft (26), from the drive shaft (26) to each propulsion member (12) in the set of propulsion members (34), and—a fluid pressure gate assembly (72) adapted to allow fluid conducted via the fluid guide conduit (15) to be fed towards the fluid actuated control assembly (38) only if a pressure of fluid exiting the fluid pressure gate assembly (72) is within a predetermined pressure range.

### TECHNICAL FIELD

The present disclosure relates to a tractor for propelling an apparatus inside a cylindrical body. Moreover, the present disclosure relates to an apparatus comprising the tractor.

### BACKGROUND

Contemporary technologies employ several different mechanisms for performing operations inside a cylindrical body, such as oil and gas wells, water injection and production pipelines. One such mechanism is a pipeline tractor. Pipeline tractors employ different mechanisms for propulsion or movements of the tractors inside a cylindrical or an elongated body.

In an example, pipeline tractors may be employed in oil and gas wells for inspection and maintenance of pipelines or hoses. These tractors are designed and built specifically for offshore use and for transporting equipment through wells. The tractors may not always be suitable for other applications such as maintenance of water pipes etc. Further, tractors in market for oil and gas wells are designed to operate in horizontal sections of wellbores.

WO 2022/129328 A1 discloses an apparatus for propulsion and operations inside a cylindrical body, such as a pipeline, and comprises a central shaft, at least one motor and motor control unit, a number of wheels arranged to rotate round the shaft with a tilted angle, and a sensor module comprising sensors. However, there is still a need for improving tractors for propelling an apparatus inside a cylindrical body.

### SUMMARY

In view of the above, an object of the present disclosure is to provide a tractor for propelling an apparatus inside a cylindrical body, which tractor can be controlled in an appropriate manner.

The above object is obtained by a first aspect of the present disclosure in accordance with claim 1.

As such, a first aspect of the present disclosure relates to a tractor for propelling an apparatus inside a cylindrical body. The tractor comprises a fluid motor. The tractor further comprises a fluid guide conduit adapted to guide fluid to the fluid motor. The tractor further comprises a set of drive portions comprising at least one drive portion wherein each drive portion in the set of drive portions comprises:
a drive shaft connected to the fluid motor whereby the drive shaft is adapted to be rotated around an axis of rotation of the drive shaft,
a set of propulsion members comprising at least one propulsion member, preferably two or more propulsion members, each propulsion member in the set of propulsion members being rotationally fixed to the drive shaft;
a fluid actuated control assembly adapted to control a largest distance, in a direction perpendicular to the axis of rotation of the drive shaft, from the drive shaft to each propulsion member in the set of propulsion members, and
a fluid pressure gate assembly adapted to allow fluid conducted via the fluid guide conduit to be fed towards the fluid actuated control assembly only if a pressure of fluid exiting the fluid pressure gate assembly is within a predetermined pressure range.

A tractor according to the above implies an appropriate control of fluid fed towards the fluid actuated control assembly. In particular, the above feature that fluid exiting the fluid pressure gate assembly is within a predetermined pressure range implies that the propulsion members may be by controlled, e.g. activated, by selecting an appropriately high pressure such that the control may be initiated by controlling the fluid pressure. Moreover, the predetermined pressure range also implies that a risk of obtaining too high a torque from the propulsion members may be appropriately low since the fluid pressure gate assembly will not allow pressures above an upper limit of the pressure range to pass the fluid pressure gate assembly.

Optionally, the predetermined pressure range is between a low pressure limit and a high pressure limit. The low pressure limit is greater than 0 bar relative pressure, preferably greater than 100 bar relative pressure. The fact that the low pressure limit is greater than any one of the above thresholds implies that there may be a range of lower pressures of e.g. fluid in the fluid guide conduit resulting in that the fluid is not fed towards the fluid actuated control assembly. This in turn implies an appropriate possibility to control as to when the fluid actuated control assembly should control the above-mentioned largest distance and when it should not.

Optionally, the high pressure limit is equal to or less than 10 times, preferably equal to or less than 5 times, more preferred equal to or less than 2 times, the low pressure limit. A high pressure limit in accordance with any one of the above examples implies an appropriately low risk that too high a torque from the propulsion members may be obtained. This is since a high pressure fed towards the fluid actuated control assembly may result in a large value of the largest distance, in a direction perpendicular to the axis of rotation of the drive shaft, from the drive shaft to each propulsion member in the set of propulsion members and this may in turn imply a large contact force between the propulsion member and an inner surface of the cylindrical body. The above risk of having too high contact force may be reduced by a high pressure limit in accordance with any one of the above examples.

Optionally, the fluid motor comprises a fluid motor fluid inlet and a fluid motor fluid exhaust. The fluid pressure gate assembly is in fluid communication with the fluid motor fluid exhaust such that at least a portion of the fluid pressure gate assembly is adapted to receive fluid from the fluid motor fluid exhaust. The above implies an efficient control of the fluid actuated control assembly since, rather than letting the fluid exhausted from the fluid motor to go to waste, the fluid pressure gate assembly and also the fluid actuated control assembly may use fluid from the fluid motor fluid exhaust.

Optionally, the fluid pressure gate assembly comprises a first pressure relief valve being adapted to allow fluid passage via the first pressure relief valve to thereby prevent the fluid from being fed towards the fluid actuated control assembly when a fluid pressure acting on the first pressure relief valve is equal to or exceeds a first pressure relief valve threshold pressure. Preferably, the first pressure relief valve is adapted to allow fluid passage via the first pressure relief valve to the environment ambient of the tractor when the fluid pressure acting on the first pressure relief valve is equal to or exceeds the first pressure relief valve threshold pressure. The above features imply that a too high fluid pressure may be prevented from passing the fluid pressure gate assembly.

Optionally, the fluid pressure gate assembly comprises a second pressure relief valve being adapted to allow fluid passage via the second pressure relief valve towards the fluid actuated control assembly when a fluid pressure acting on the second pressure relief valve is equal to or exceeds a second pressure relief valve threshold pressure. The above features imply that fluid may be allowed to pass the fluid pressure gate assembly, in the event that the fluid pressure is sufficiently high, in a straightforward manner.

Optionally, at least one drive portion, preferably each drive portion, in the set of drive portions comprises a pressure booster located between the fluid pressure gate assembly and the fluid actuated control assembly, as seen in a direction of flow from the fluid pressure gate assembly to the fluid actuated control assembly. The pressure booster comprises a pressure booster inlet and a pressure booster outlet, wherein the pressure booster is such that when in use, fluid exiting the pressure booster outlet has a higher pressure than fluid entering the pressure booster inlet, preferably the pressure booster being adapted to be powered by the fluid entering the pressure booster inlet. The boost pressure may be used for increasing the pressure of the fluid fed to the fluid actuated control assembly which may simplify the control of the fluid actuated control assembly. Moreover, the pressure booster implies that the fluid conducted via the fluid guide conduit need not have a high pressure in order to control the fluid actuated control assembly in an appropriate manner. Instead, the fluid conducted via the fluid guide conduit needs only to have a pressure high enough allowing it to pass the fluid pressure gate assembly and the pressure of the fluid actually reaching the fluid actuated control assembly may be higher than the pressure in the fluid guide conduit. This in turn implies that the predetermined pressure range may be selected such that an appropriate control of the fluid motor is obtained but that the fluid actuated control assembly may be controlled when desired without the need for increasing the pressure in the fluid guided in the fluid guide conduit to an excessive extent.

Optionally, at least one drive portion, preferably each drive portion, in the set of drive portions comprises a fluid actuated control assembly exhaust located downstream the fluid actuated control assembly, as seen in a direction of flow to the fluid actuated control assembly from the fluid pressure gate assembly. Preferably the fluid actuated control assembly exhaust is adapted to discharge fluid to the environment ambient of the tractor.

Optionally, the fluid guide conduit comprises, or is constituted by, at least one of the following: a coiled tubing or a set of threaded drill strings. When the tractor is propelled by means of the propulsion members, the propulsion members are in contact with an inner surface of the cylindrical body. As such, a torque is generated around the tractor when the drive shaft rotates around its axis of rotation. Such a torque may rotate the tractor relative to the cylindrical body during propulsion, which rotation may be undesired since for instance it may impair the propulsion of the tractor. The coiled tubing or the set of threaded drill strings may provide a counteracting torque that may mitigate the risk of the tractor being rotated relative to the cylindrical body during use.

Optionally, for at least one drive portion, preferably each drive portion, in the set of drive portions, each propulsion member in the set of propulsion members comprises a rim enclosing the drive shaft, preferably each propulsion member in the set of propulsion members comprises a wheel that in turn comprises the rim.

Optionally, the fluid actuated control assembly is adapted to control an eccentricity of the rim relative to the drive shaft to thereby control the largest distance, in a direction perpendicular to the axis of rotation of the drive shaft, from the drive shaft to each propulsion member in the set of propulsion members.

Optionally, the rim extends in a rim plane. The rim plane forms a rim angle with the axis of rotation of the drive shaft. The rim angle is less than 90°, preferably less than 88°, more preferred less than 85°.

Optionally, for at least one drive portion, preferably each drive portion, in the set of drive portions, each propulsion member in the set of propulsion members comprises a propulsion member contact portion adapted to contact an inner surface of the cylindrical body, the largest distance from the drive shaft to the propulsion member being a distance from the drive shaft to the propulsion member contact portion in the direction perpendicular to the axis of rotation of the drive shaft.

Optionally, for at least one drive portion, preferably each drive portion, in the set of drive portions, each propulsion member in the set of propulsion members is adapted to transfer a force from an inner surface of the cylindrical body to the drive shaft when the largest distance is equal to or above a largest distance threshold. The above implies that the propulsion member may be brought into contact with the inner surface of the cylindrical body by increasing the largest distance.

Optionally, for at least one drive portion, preferably each drive portion, in the set of drive portions, each propulsion member in the set of propulsion members is such that when the drive shaft rotates around the axis of rotation and the propulsion member transfers a force from the inner surface of the cylindrical body to the drive shaft, a propulsion force is imparted on the tractor.

Optionally, for at least one drive portion, preferably each drive portion, in the set of drive portions, each propulsion member in the set of propulsion members is such that when the drive shaft rotates around the axis of rotation and the propulsion member transfers a force from the inner surface of the cylindrical body to the drive shaft, a contact point between the propulsion member and the inner surface of the cylindrical body will vary as the drive shaft rotates around the axis of rotation such that a trajectory of subsequent contact points will form a helical shape on the inner surface of the cylindrical body.

Optionally, the cylindrical body has a longitudinal extension in a longitudinal cylindrical body direction. The tractor is adapted to propel the apparatus in a direction parallel to and/or coaxial with the longitudinal cylindrical body direction. The above implies a compact tractor.

Optionally, for at least one drive portion, preferably each drive portion, in the set of drive portions, when in use, the axis of rotation of the drive shaft and the longitudinal cylindrical body direction form an angle having an absolute value being less than 10°, preferably the axis of rotation of the drive shaft being parallel to and/or coaxial with the longitudinal cylindrical body direction.

A second aspect of the present disclosure relates to a tractor assembly comprising a tractor according to the first aspect of the present disclosure, wherein the fluid guide conduit is rotationally fixed to a portion of the tractor. The tractor assembly further comprises a fluid guide conduit rotational lock adapted to prevent a portion of the fluid guide conduit from rotating relative to a portion of the cylindrical body. As indicated above, a torque may be generated when the drive shaft rotates around its axis of rotation and the propulsion members are in contact with an inner surface of the cylindrical body. Such a torque may rotate the tractor relative to the cylindrical body during propulsion. The fluid guide conduit rotational lock may provide a counteracting torque that may mitigate the risk of the tractor being rotated relative to the cylindrical body during use.

A third aspect of the present disclosure relates to an apparatus comprising a sensor and/or a tool and the tractor according to the first aspect of the present disclosure or a tractor assembly according to the second aspect of the present disclosure.

Optionally, the tool is adapted to receive fluid from a fluid actuated control assembly exhaust of at least one of the drive portion in the set of drive portions.

A fourth aspect of the present disclosure relates to a cylindrical body assembly comprising a cylindrical body and the tractor according to the first aspect of the present disclosure, the tractor assembly according to according to the second aspect of the present disclosure or the apparatus according to the third aspect of the present disclosure.

### BRIEF DESCRIPTION OF THE DRAWINGS

With reference to the appended drawings, below follows a more detailed description of embodiments of the disclosure cited as examples.

In the drawings:

FIG. 1 is a schematic perspective view of a tractor for propelling an apparatus inside a cylindrical body;

FIG. 2 is an exploded view of the tractor presented in FIG. 2;

FIGS. 3a-3d illustrate an implementation of a fluid actuated control assembly;

FIG. 4a illustrates another implementation of a fluid actuated control assembly;

FIG. 4b illustrates a helical shape;

FIG. 5 illustrates schematically a hydraulic system of a tractor for propelling an apparatus inside a cylindrical body;

FIGS. 6a-6b illustrate embodiments of a tractor;

FIGS. 7a-6c illustrate a tractor in different conditions;

FIGS. 8-10 illustrate add-ons to a tractor for propelling an apparatus inside a cylindrical body, and

FIG. 11 illustrates different configurations of a tractor.

### DETAILED DESCRIPTION OF PREFERRED EMBODIMENTS

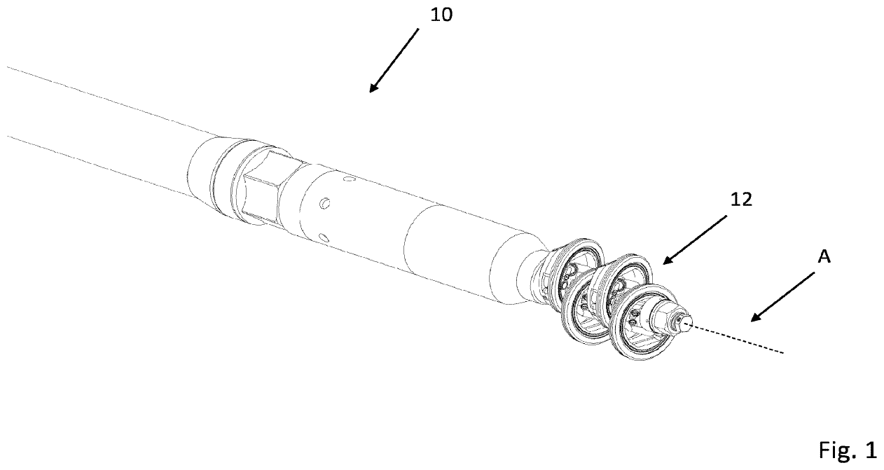

FIG. 1 illustrates a tractor 10 for propelling an apparatus inside a cylindrical body (not shown in FIG. 1). In the example illustrated in FIG. 1, the tractor 10 comprises a set of propulsion members 12, implemented as wheels in the FIG. 1 example. When the propulsion members 12 rotate around an axis of rotation A and the propulsion members 12 are in contact with an inner surface of the cylindrical body, a propulsion force in a direction parallel to the axis of rotation may be obtained. The propulsion force is obtained by virtue of the fact that each propulsion member 12 will undergo a helical motion relative to the cylindrical body, as explained in WO 2022/129328 A1.

In the following description, the term “cylindrical body” is used to describe any kind of body having an elongated extending opening, such as a pipeline, duct, channel, tube, drilled well with or without casing. Examples are flexible risers, umbilicals, oil or gas wells during or after drilling, oil or gas production pipelines, water pipes, waste pipes, process plant pipelines, geothermal wells, etc.

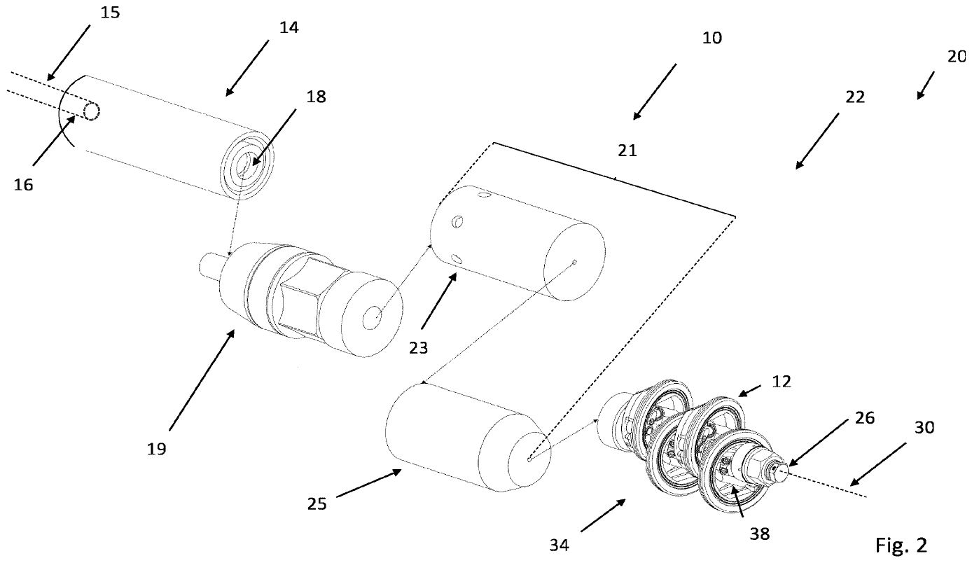

FIG. 2 illustrates an embodiment of a tractor 10 for propelling an apparatus inside a cylindrical body (not shown in FIG. 2). The tractor 12 comprises a fluid motor 14. The tractor further comprises a fluid guide conduit 15 adapted to guide fluid to the fluid motor 14. The tractor further comprises a set of drive portions 22 comprising at least one drive portion. In the FIG. 2 example, the set of drive portions 20 comprises one drive portion 22. However, it is envisaged that other embodiments of the tractor 10 may comprise a set of drive portions 20 comprising two or more drive portions.

Moreover, as indicated in FIG. 2, each drive portion 22 in the set of drive portions 20, exemplified by the single drive portion 22 in FIG. 2, comprises a drive shaft 26 connected to the fluid motor 14 whereby the drive shaft 26 is adapted to be rotated around an axis of rotation 30 of the drive shaft 26.

As a non-limiting example, the fluid motor 14 may be powered by a gas, such as air. As another non-limiting example, the fluid motor 14 may be powered by a liquid, such as oil or water. As such, the fluid guide conduit 15 may be adapted to a gas and/or a liquid in accordance with any one of the above examples to the fluid motor 14.

Purely by way of example, a drive shaft 26 may be directly connected to the fluid motor 14. However, it is also envisaged that in embodiments of the tractor 10, at least one drive shaft 26 may be indirectly connected to the fluid motor 14. Such an implementation is indicated in FIG. 2, illustrating a non-limiting example in which the drive shaft 26 is connected to the fluid motor 14 via an interface module 19 and at least one least one flow module 21. In the non-limiting FIG. 2 example, the flow module 21 comprises a high-flow module 23 and a low-flow module 25. Irrespective of the implementation of the connections between the fluid motor 14 and the drive shaft 26, the connections are preferably such that a rotation of a portion of the fluid motor 14, such as a stator or rotor (not shown) of the fluid motor 14, can be transferred to a rotation of the shaft 26.

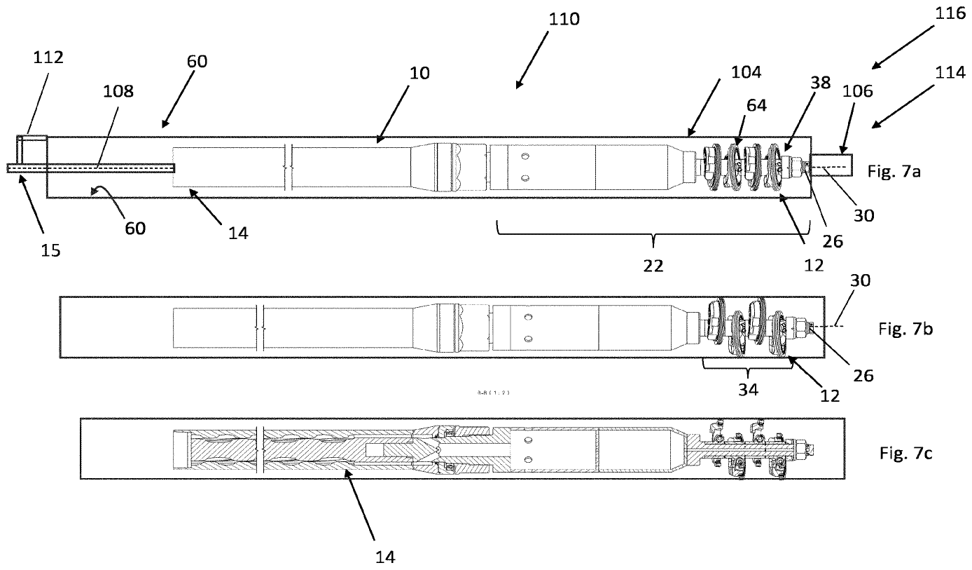

Moreover, as indicated in FIG. 2, each drive portion 22 in the set of drive portions 20 comprises a set of propulsion members 34 comprising at least one propulsion member 12, preferably two or more propulsion members. Each propulsion member 12 in the set of propulsion members 34 is rotationally fixed to the drive shaft 26. In the FIG. 2 embodiment, the set of propulsion members 34 comprises four propulsion members 12, each one of which comprising a rim as will be elaborated on hereinbelow. A set of propulsion members 34 comprising two or more propulsion members implies an increased possibility to keep the drive shaft 26 radially in place relative to a cylindrical body 60 (see e.g. FIG. 7b hereinbelow) during propulsion of the tractor 10.

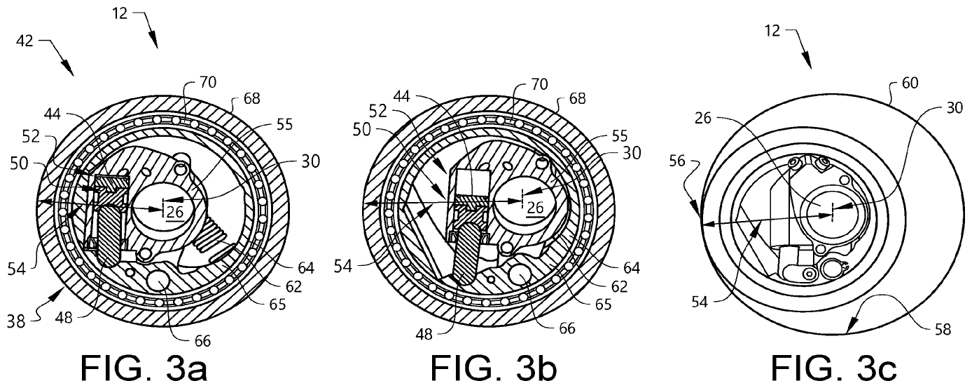

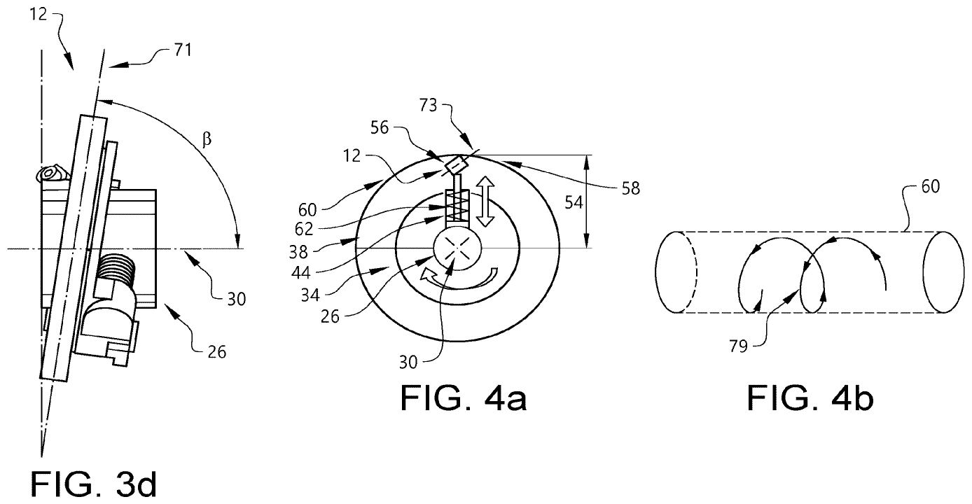

Furthermore, each drive portion 22 in the set of drive portions 20 comprises a fluid actuated control assembly 38 adapted to control a largest distance 54 (see FIG. 3a below), in a direction perpendicular to the axis of rotation 30 of the drive shaft 26, from the drive shaft 26 to each propulsion member 12 in the set of propulsion members 34.

Purely by way of example, and as indicated in FIG. 2, the modules 19, 23, 24 and the drive portion 22 may comprise connecting means and may be configured to be releasably connected to each other in series. To this end, the connecting means may comprise a bolt joint (not shown) adapted to connect together adjacent components. As another non-limiting example, the connecting means may comprise threaded members, not shown, such that adjacent components may be connected together by means of a relative rotation between the components. Moreover, the modules 19, 23, 25 and the drive portion 22 may be such that a fluid flow may be conducted from the fluid guide conduit 15 to the fluid actuated control assembly 38 via each one of the modules 19, 23, 25, such as each one of the interface module 19, the high-flow module 23 and a low-flow module 25 in the FIG. 2 example. To this end, each one of the modules 19, 23, 25 may comprise one or more conduits (not shown in FIG. 2) for guiding fluid from the fluid guide conduit 15 to the fluid actuated control assembly 38. As a non-limiting example, each one of the modules 19, 23, 25 may comprise one or more conduits (not shown in FIG. 2) for guiding fluid from a fluid motor fluid exhaust 18 to the fluid actuated control assembly 38.

Moreover, although the FIG. 2 example of the set of drive portions 20 comprises a single drive portion 22, it is also envisaged that other embodiments of the tractor 10 may comprise a plurality of drive portions (not shown i FIG. 2). Purely by way of example, it is envisaged that embodiments of the tractor 10 may comprise a set of drive portions 20 comprising two drive portions (not shown), for instance a first drive portion located between the fluid guide conduit 15 and a fluid motor fluid inlet 16 and a second drive portion downstream the fluid motor fluid exhaust 18, as seen in a direction of flow of fluid from the fluid guide conduit 15 to the second drive portion.

As regards the fluid actuated control assembly 38, reference is made to FIGS. 3a-3d illustrating a portion of an implementation of a fluid actuated control assembly 38. The implementation in FIGS. 3a-3d is exemplified using a portion of the fluid actuated control assembly 38 of the first drive portion 22 as an example. However, the FIGS. 3a-3d implementation could be used for any fluid actuated control assembly of the tractor 10.

As indicated in FIGS. 3a-3d, the control assembly 38 may comprise a set of fluid-controlled actuators 42, such that each propulsion member in the set of propulsion members is connected to an individual fluid-controlled actuator in the set of fluid-controlled actuators. FIGS. 3a-3d illustrate a single fluid-controlled actuator 44 that forms part of the set of fluid-controlled actuators 42 and which is adapted to control a single propulsion member 12 of the set of propulsion members 34 associated with the first drive portion 22.

However, it is also envisaged that other implementations of the fluid actuated control assembly 38, 40 may comprise a fluid-controlled actuator that is adapted to jointly control two or more propulsion members of a set of propulsion members 34.

In the implementation illustrated in FIGS. 3a-3d, the fluid-controlled actuator 44 comprises a fluid cylinder 48 with a piston 50 and a piston chamber 52.

Each fluid-controlled actuator 44 in the set of fluid-controlled actuators 42, wherein again a single fluid-controlled actuator 44 is used as an example in FIGS. 3a-3d, is adapted to increase the largest distance 54, in a direction perpendicular to the axis of rotation 30 of the drive shaft 26 (see FIG. 2), from the drive shaft 26 to an individual propulsion member 12 in the set of propulsion members 34, when pressure of fluid fed to the fluid-controlled actuator 44 is equal to or above a fluid control threshold pressure. To this end, though purely by way of example, the propulsion member 12 may comprise a hub 55 that is adapted to be connected to the drive shaft 26. Thus, the largest distance 54 may be associated with a distance from the centre of the hub 55 to a portion of the individual propulsion member 12.

To this end, reference is made to FIG. 3a and FIG. 3b. In FIG. 3a, the fluid-controlled actuator 44 is in a retracted condition in which the above-mentioned largest distance 54 is relatively small. However, in FIG. 3b, the fluid-controlled actuator 44 is in an expanded condition in which the largest distance 54 is larger than in the FIG. 3a condition. The condition of the fluid-controlled actuator 44 indicated in FIG. 3b has been obtained by feeding fluid to the piston chamber 52 to thereby expand the fluid-controlled actuator 44. Purely by way of example, and as indicated in FIG. 3c, for at least one drive portion, preferably each drive portion, in the set of drive portions, each propulsion member 12 in the set of propulsion members comprises a propulsion member contact portion 56 adapted to contact an inner surface 58 of a cylindrical body 60 within which the tractor is operating. The largest distance 54 from the drive shaft 26 to the propulsion member 12 constitutes the distance from the drive shaft 26 to the propulsion member contact portion 56 in the direction perpendicular to the axis of rotation 30 of the drive shaft 26. This is illustrated in FIG. 3c using a single propulsion member 12.

As such, when the largest distance 54 is relatively small, such as in the FIG. 3a condition, there may be no contact between the propulsion member 12 and the inner surface 58 of the cylindrical body 60 (the cylindrical body 60 is illustrated in FIG. 3c). Consequently, even when the propulsion member 12 rotates around the axis of rotation 30, such a rotation will not create a propulsion force between the tractor 10 and the cylindrical body 60.

However, when the largest distance 54 is relatively large, such as in the FIGS. 3b and 3c conditions, contact is established between the propulsion member 12 and the inner surface 58 of the cylindrical body 60. As such, when the propulsion member 12 rotates around the axis of rotation 30, such a rotation creates a propulsion force between the tractor 10 and the cylindrical body 60.

In other words, the fluid-controlled actuator 44 in the FIGS. 3a-3d implementation can be used for controlling whether or not there should be contact between the propulsion member 12 and the inner surface 58 of the cylindrical body 60.

Moreover, though purely by way of example, FIGS. 3a-3d illustrate that the control assembly may comprise a biasing arrangement 62 adapted to bias each propulsion member 12 in the set of propulsion members 34 towards a position with a minimum largest distance 54, in a direction perpendicular to the axis of rotation 30 of the drive shaft 26, from the drive shaft 26 to the propulsion member 12. In the FIGS. 3a-3d implementation, the biasing arrangement 62 is exemplified by a single biasing member, such as a spring, adapted to bias a single propulsion member 12 in the set of propulsion members 34 towards a position with a minimum largest distance 54, in a direction perpendicular to the axis of rotation 30 of the drive shaft 26, from the drive shaft 26 to the propulsion member 12. However, in other implementations of the control assembly, the biasing arrangement 62 may comprise one or more biasing members adapted to bias two or more propulsion members towards positions in which each propulsion member has a minimum largest distance 54.

Moreover, as indicated in FIGS. 3a-3d, for at least one drive portion, preferably each drive portion, in the set of drive portions, each propulsion member 12 in the set of propulsion members comprises a rim 64 enclosing the drive shaft 26. Preferably each propulsion member in the set of propulsion members comprises a wheel 65 that in turn comprises the rim 64. Purely by way of example, and as indicated in FIGS. 3a and 3b, the rim 64 may be pivotally connected to the hub 55 via a pivotal connection point 66 which for instance may comprise a rotary bolt. Moreover, as indicated in FIG. 3a for instance, the propulsion member 12 may comprise a friction member 68 circumferentially enclosing the rim 64. Purely by way of example, the friction member 68 may be referred to as a tyre. As a non-limiting example, a bearing 70 may be located between the rim 64 and the friction member 68.

As such, though purely by way of example, when the pressure increases in the piston chamber 52, the piston 50 will be pushed along the piston chamber 52 whereby the rim 64 will rotate about the pivotal connection point 66 such that the hub 55 and the rim 64 will become eccentric, as illustrated in FIGS. 3b and 3c, respectively. The friction member 68 will push against the inner surface 58 of the cylindrical body 60, as illustrated in FIG. 3c, and create a friction connection at the friction member contact portion 56. The bearing 70 allows the friction member 68 to rotate freely on the rim 64.

As may be realized from the above, each propulsion member 12 of a set of propulsion members comprises one of the rims 64. The control assembly may be adapted to control the eccentricity of the rim 64 of each propulsion member relative to the drive shaft 26 to thereby control the largest distance 54, in a direction perpendicular to the axis of rotation 30 of the drive shaft 26, from the drive shaft 26 to each propulsion member 12 in the set of propulsion members.

As indicated above, FIG. 3c illustrates a propulsion member 12 with its rim 64 in an eccentric condition such that the propulsion member contact portion 56 of the friction member 68 is in contact with the inner surface 58 of the cylindrical body 60. As such, the rim 64 will impart a force on a portion of the friction member 68 which will contact the inner surface 58 of the cylindrical body 60.

When the drive shaft 26 rotates around its axis of rotation 30, the rim 64 will rotate with the drive shaft 26. Due to the bearing 70 between the rim 64 and the friction member 68, the rim 64 will subsequently impart a force on another portion (adjacent to the previous portion) of the friction member 68 which will then contact the inner surface 58 of the cylindrical body 60. As such, the rotation of the drive shaft 26 and thus the rim 64 will result in that the contact point between the friction member 68 and the inner surface 58 of the cylindrical body 60 will propagate along the circumference of the friction member 68. Due to the fact that the propulsion member 12 is tilted relative to the drive shaft, as will be elaborated on hereinbelow, the above propagation of the contact point will result in a frictional force which may be substantially parallel to the axis of rotation 30 such that propulsion force being substantially parallel to the axis of rotation 30 is obtained. Moreover, the tilted propulsion member 12 and the propagating contact force as presented above will result in that the contact between the friction member 68 and the inner surface 58 of the cylindrical body 60 will form a helical path along the inner surface 58.

To this end, FIG. 3d illustrates a side view of a propulsion member 12. As illustrated in FIG. 3d, the propulsion member 12 may be tilted relative to the drive shaft 26. Thus, as indicated in FIG. 3d, the rim 64 may extend in a rim plane 71 (see FIG. 3d) and the rim plane 71 may form a rim angle ß with the axis of rotation 30 of the drive shaft 26. As may be realized from FIG. 3d, the rim plane 71 may actually form two angles with the axis of rotation 30, a first angle from the rim plane 71 to the axis of rotation 30 to the right of the rim plane 71 and a second angle from the rim plane 71 to the axis of rotation 30 to the left of the rim plane 71. As used herein, and as indicated in FIG. 3d, the rim angle β relates to the smallest angle from the rim plane 71 to the axis of rotation 30 of the drive shaft 26. As indicated in FIG. 3d, the rim angle β is less than 90° such that the propulsion member 12 may be regarded as tilted relative to the drive shaft 26. Purely by way of example, the rim angle β may be less than 88°, preferably less than 85°.

As other non-limiting examples, the rim angle β may be greater than 45°, preferably greater than 65°, more preferred greater than 75°.

As a non-limiting example, the tractor 10 may be such that the rim angle β can be adjusted for each propulsion member 12. As a non-limiting option, the tractor may comprise one or more adjustable members (not shown), such as bolts or the like, by which it is possible to set the rim angle β. As another non-limiting alternative, the fluid actuated control assembly 38 may also have the capability to adjust the rim angle β for each propulsion member 12.

The above features with the rim plane 71 and the rim angle β may apply for every propulsion member 12.

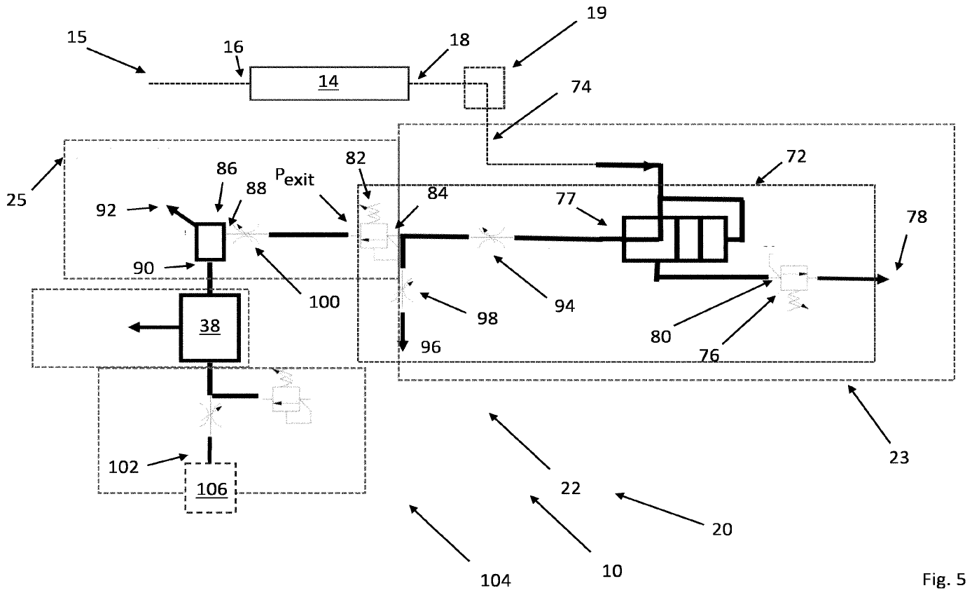

It should be noted that the fluid actuated control assembly 38 may be implemented in a plurality of ways instead of, or in addition to, the implementation presented above with reference to FIGS. 3a-3d . To this end, though purely by way of example, reference is made to FIG. 4a illustrating a portion of another implementation of the fluid actuated control assembly 38.

FIG. 4a illustrates an example with a set of propulsion members 34 on which a single propulsion member 12 of the set of propulsion members 34 associated with the first drive portion 22 is illustrated for the sake of clarity. In the FIG. 4a example, the propulsion member 12 is implemented as a roll that is adapted to be rotated around the axis of rotation 30 of the drive shaft 26 of the first drive portion 22. Moreover, as indicated in FIG. 4a, a fluid-controlled actuator 44 may control the largest distance 54, in a direction perpendicular to the axis of rotation 30 of the drive shaft 26, from the drive shaft 26 to the individual propulsion member 12. In FIG. 4a, the fluid-controlled actuator 44 is implemented as a fluid cylinder. As indicated by the double arrow in FIG. 4a, the largest distance 54 may be altered by actuating the fluid-controlled actuator 44.

Moreover, though purely by way of example, FIG. 4a illustrates that the control assembly may comprise a biasing arrangement 62 adapted to bias each propulsion member 12 in the set of propulsion members 42 towards a position with a minimum largest distance 54, in a direction perpendicular to the axis of rotation 30 of the drive shaft 26, from the drive shaft 26 to the propulsion member 12. In the FIG. 4a implementation, the biasing arrangement 62 is exemplified by a single biasing member, such as a spring, adapted to bias a single propulsion member 12 in the set of propulsion members 42 towards a position with a minimum largest distance 54, in a direction perpendicular to the axis of rotation 30 of the drive shaft 26, from the drive shaft 26 to the propulsion member 12.

The largest distance 54 from the drive shaft 26 to the propulsion member 12 is the distance from the drive shaft 26 to the propulsion member contact portion 56 in the direction perpendicular to the axis of rotation 30 of the drive shaft 26.

Purely by way of example, the propulsion member contact portion 56 in FIG. 4a may comprise a roll that is adapted to rotate around a roll axis of rotation 73, wherein the roll axis of rotation 73 forms an angle with the axis of rotation 30 of the drive shaft 26 which is in the range of 30-80°. Alternatively, the fluid-controlled actuator 44 or any other connector connecting the drive shaft 26 to the propulsion member 12 in FIG. 4a may be tilted relative to the drive shaft 26 in a similar way as presented hereinabove with reference to FIG. 3d. Thereby, a rotation of the drive shaft 26 around the axis of rotation 30 will result in a propulsion force in a manner similar to the one that has been presented hereinabove with reference to FIG. 3c and FIG. 3d.

As may be realized from the FIGS. 3a-3d and FIG. 4a implementations, a fluid actuated control assembly 38 forming part of a drive portion 22 may be implemented in a plurality of different ways.

However, irrespective of the actual implementation of the fluid actuated control assembly 38, the fluid actuated control assembly 38 is adapted to control a largest distance 54, in a direction perpendicular to the axis of rotation 30 of the drive shaft 26, from the drive shaft 26 to each propulsion member in the set of propulsion members 34.

Furthermore, purely by way of example and as indicated in each one of the FIGS. 3a-3d and FIG. 4a implementations, for at least one drive portion 22, preferably each drive portion, in the set of drive portions 20, each propulsion member 12 in the set of propulsion members 34 is adapted to transfer a force from an inner surface 58 of the cylindrical body 60 to the drive shaft 26 when the largest distance 54 is equal to or above a largest distance threshold. As a non-limiting example, a contact between a propulsion member 12 and the inner surface 58 of the cylindrical body 60 may result in that a resulting force, for instance comprising a contact force component and frictional force component, is imparted on the propulsion member 12 and transferred to the drive shaft 26.

As may be realized from the above, by way of example only, the largest distance threshold may be dependent on the diameter of the cylindrical body 60.

Additionally, purely by way of example and as also indicated in each one of the FIG. 3a-3d and FIG. 4a implementations, for at least one drive portion 22, preferably each drive portion, in the set of drive portions 20, each propulsion member 12 in the set of propulsion members 34 is such that when the drive shaft 26 rotates around the axis of rotation 30 and the propulsion member 12 transfers a force from the inner surface 58 of the cylindrical body 60 to the drive shaft 26, a propulsion force is imparted on the tractor 10.

Here, it should also be noted that, by way of example only, for at least one drive portion 22, preferably each drive portion, in the set of drive portions 20, each propulsion member 12 in the set of propulsion members 34 is such that when the drive shaft 26 rotates around the axis of rotation 30 and the propulsion member 12 transfers a force from the inner surface 58 of the cylindrical body 60 to the drive shaft 26, a contact point between the propulsion member 12 and the inner surface 58 of the cylindrical body 60 will vary as the drive shaft 26 rotates around the axis of rotation 30 such that a trajectory 79 of subsequent contact points will form a helical shape on the inner surface 58 of the cylindrical body 60. Such a helical shape is indicated in FIG. 4b. It should be noted that the helical shape indicated in FIG. 4b may be obtained for a plurality of different implementations of the propulsion member 12, such as any one of the implementations presented hereinabove with reference to FIGS. 3a-3d and FIG. 4a.

Moreover, with reference to FIG. 5, each drive portion 22 in the set of drive portions 20 comprises a fluid pressure gate assembly 72 adapted to allow fluid conducted via the fluid guide conduit 15 (see FIG. 2) to be fed towards the fluid actuated control assembly 38 only if a pressure Pₑₓᵢₜ Of fluid exiting the fluid pressure gate assembly 72 is within a predetermined pressure range.

As indicated in FIG. 5, the fluid motor 14 comprises a fluid motor fluid inlet 16 and a fluid motor fluid exhaust 18. Moreover, FIG. 5 illustrates an embodiment in which the fluid pressure gate assembly 72 is in fluid communication with the fluid motor fluid exhaust 18 such that at least a portion of the fluid pressure gate assembly 72 is adapted to receive fluid from the fluid motor fluid exhaust 18. As a non-limiting example, the fluid motor fluid exhaust 18 may be in fluid communication with at least a portion of the fluid pressure gate assembly 72 via a conduit assembly 74 comprising one or more conduits. Purely by way of example, the conduit assembly 74 may comprise a conduit portion forming part of the interface module 19 as has been presented above with reference to FIG. 2.

By way of example only, the predetermined pressure range may be between a low pressure limit P_{low} and a high pressure limit P_{high}. As a non-limiting example, the low pressure limit P_{low} may be greater than 0 bar relative pressure, preferably greater than 100 bar relative pressure. Put differently, the low pressure limit P_{low} may be greater than 0 bar relative the pressure ambient of the tractor 10, preferably greater than 100 bar relative the pressure ambient of the tractor 10. As another non-limiting example, the low pressure limit P_{low} may be greater than an absolute pressure of 1, preferably greater than 100 bar, more preferred greater than 200 bar.

Moreover, again by way of example only, the high pressure limit P_{high} may be equal to or less than 10 times, preferably equal to or less than 5 times, more preferred equal to or less than 2 times, the low pressure limit P_{low}.

FIG. 5 also illustrates an exemplary implementation of the fluid pressure gate assembly 72. As indicated in FIG. 5, the fluid pressure gate assembly 72 may comprise a first pressure relief valve 76 adapted to allow fluid passage via the first pressure relief valve 76 to thereby prevent the fluid from being fed towards the fluid actuated control assembly 38 when a fluid pressure acting on the first pressure relief valve 76 is equal to or exceeds a first pressure relief valve threshold pressure. Preferably, and as indicated in FIG. 5 implementation, the first pressure relief valve 76 may be adapted to allow a fluid passage via the first pressure relief valve 76 to the environment ambient of the tractor 10, as indicated by arrow 78 in FIG. 5, when the fluid pressure acting on the first pressure relief valve 76 is equal to or exceeds the first pressure relief valve threshold pressure.

As a non-limiting example, and as exemplified in FIG. 5, the first pressure relief valve 76 may comprise a first pressure relief valve inlet 80 and the first pressure relief valve 76 may be adapted to allow fluid passage via the first pressure relief valve 76 to thereby prevent the fluid from being fed towards the fluid actuated control assembly 38 when a fluid pressure acting on the first pressure relief valve inlet 80 is equal to or exceeds a first pressure relief valve threshold pressure.

Moreover, the first pressure relief valve 76 may be adapted to prevent fluid passage via the first pressure relief valve 76 when the fluid pressure acting on the first pressure relief valve 76, e.g. when the fluid pressure acting on the first pressure relief valve inlet 80 as indicated above, is lower than the first pressure relief valve threshold pressure.

By way of example only, and as also indicated in FIG. 5, the fluid pressure gate assembly 72 may comprise a second pressure relief valve 82 adapted to allow fluid passage via the second pressure relief valve 82 towards the fluid actuated control assembly 38 when a fluid pressure acting on the second pressure relief valve 82 is equal to or exceeds a second pressure relief valve threshold pressure. As a non-limiting example, and as exemplified in FIG. 5, the second pressure relief valve 82 may comprise a second pressure relief valve inlet 84 and the second pressure relief valve 82 may be adapted to allow fluid passage via the second pressure relief valve 82 towards the fluid actuated control assembly 38 when a fluid pressure acting on the second pressure relief valve inlet 84 is equal to or exceeds a second pressure relief valve threshold pressure.

Further, by way of example only, the fluid pressure gate assembly 72 may comprise a pilot pressure operated control valve 77. By way of example only, the pilot pressure operated control valve 77 may be adapted to prevent fluid being fed towards the second pressure relief valve 82 if the pressure of the fluid is high, e.g. equal to or above the first pressure relief valve threshold pressure.

Moreover, again with reference to FIG. 5 though by way of example only, the at least one drive portion 22, preferably each drive portion, in the set of drive portions 20 (see FIG. 2) comprises a pressure booster 86 located between the fluid pressure gate assembly 72 and the fluid actuated control assembly 38, as seen in a direction of flow from the fluid pressure gate assembly 72 to the fluid actuated control assembly 38.

As indicated in FIG. 5, the pressure booster 86 comprises a pressure booster inlet 88 and a pressure booster outlet 90. The pressure booster 86 is such that when in use, fluid exiting the pressure booster outlet 90 has a higher pressure than fluid entering the pressure booster inlet 88. Preferably, the pressure booster 86 is adapted to be powered by the fluid entering the pressure booster inlet 88.

Moreover, by way of example only, the pressure booster 86 may also comprise a pressure booster exhaust 92. Purely by way of example, the pressure booster exhaust 92 may be adapted to discharge fluid to the environment ambient of the tractor 10. As such, though purely by way of example, the pressure booster 86 may be such that when in use, fluid exiting the pressure booster outlet 90 has a lower mass flow than fluid entering the pressure booster inlet 88.

Further, as indicated in the non-limiting example illustrated in FIG. 5, the fluid pressure gate assembly 72 may comprise an internal throttling 94 adapted to throttle a fluid flow from the first pressure relief valve 76 to the second pressure relief valve 82. Preferably, the internal throttling 94 may be an adjustable internal throttling.

Moreover, by way of example and as also indicated in FIG. 5, the fluid pressure gate assembly 72 may comprise a fluid pressure gate assembly exhaust 96 located upstream the second pressure relief valve 82. Moreover, the fluid pressure gate assembly 72 may comprise an exhaust throttling 98 adapted to throttle a fluid flow towards the fluid pressure gate assembly exhaust 96. Preferably, the exhaust throttling 98 may be an adjustable exhaust throttling.

As such, fluid reaching the second pressure relief valve 82 but not having a high enough pressure in order to pass via the second pressure relief valve 82 may be discharged via the fluid pressure gate assembly exhaust 96.

Purely by way of example, the first pressure relief valve 76 and the second pressure relief valve 82 may be arranged in different modules. As such, with reference to FIG. 5 as well as to FIG. 2, the first pressure relief valve 76 may form part of a high-flow module 23 and the second pressure relief valve 82 may form part of a low-flow module 25. Moreover, as indicated in FIG. 2, the high-flow module 23 and the low-flow module 25 may be separate components that are adapted to be releasably connected to each other.

As may be realized from the above and from FIG. 5, a mass flow of fluid exiting the high-flow module 23 may be higher than a mass flow of fluid exiting the low-flow module 25, hence the use of the terms high-flow module and low-flow module, respectively. Moreover, as may be realized from the above, a pressure of the fluid exiting the high-flow module 23 may be lower than a pressure of the fluid exiting the low-flow module 25. As such, the high-flow module may alternatively be referred to as a low pressure module and the low-flow module 25 may alternatively be referred to as a high pressure module.

Moreover, as a non-limiting example, at least one drive portion 22, preferably each drive portion, in the set of drive portions 20 comprises a fluid actuated control assembly exhaust 102 located downstream the fluid actuated control assembly 38, as seen in a direction of flow to the fluid actuated control assembly 38 from the fluid pressure gate assembly 72. Preferably, the fluid actuated control assembly exhaust 102 is adapted to discharge fluid to the environment ambient of the tractor 10.

Purely by way of example, the tractor 10 may form part of an apparatus 104 comprising for instance a tool 106 and the tractor 10, see also the below description with reference to FIG. 7a. By way of example only, and as indicated in FIG. 5, the tool 106 may be adapted to receive fluid from a fluid actuated control assembly exhaust 102 of at least one of the drive portions 22 in the set of drive portions 20. In fact, in the FIG. 5 example, the tool 106 is adapted to receive fluid from the fluid actuated control assembly exhaust 102 of the single drive portion 22 presented in the FIG. 5 example.

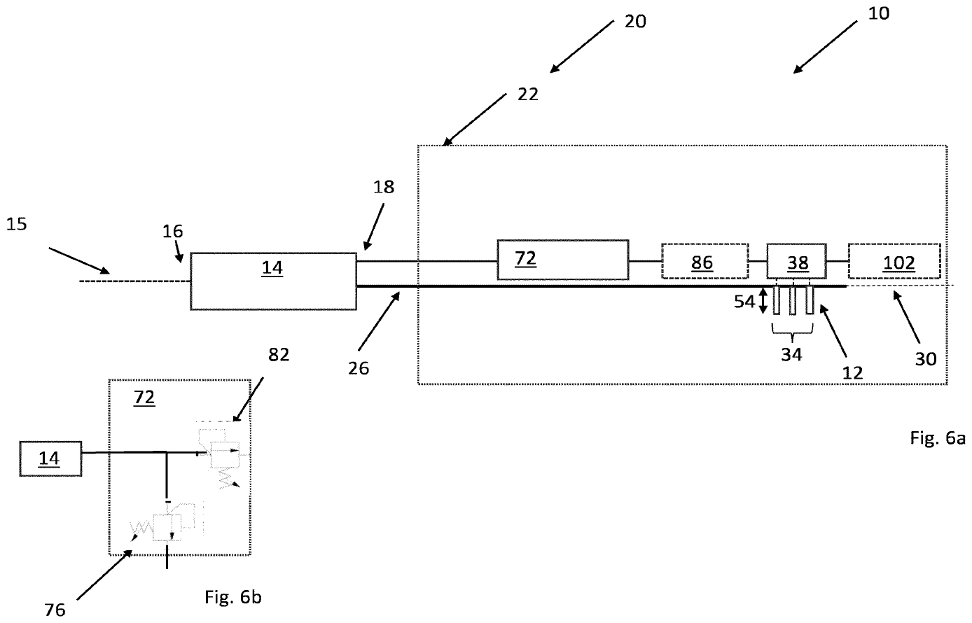

It should be noted that FIG. 5 merely serves as an example of a tractor 10 in accordance with the present disclosure. To this end, FIG. 6a illustrates another embodiment of the tractor 10. As may be gleaned from FIG. 6a, the embodiment of the tractor 10 illustrated therein comprises a fluid motor 14. The tractor further comprises a fluid guide conduit 15 adapted to guide fluid to the fluid motor 14. The tractor 14 further comprises a set of drive portions comprising at least one drive portion 22. As for FIG. 5, the FIG. 6a example comprises a single drive portion 22 but it is also envisaged that embodiments of the tractor may comprise two or more drive portions. Irrespective of the number of drive portions, each drive portion 22 in the set of drive portions 20 comprises the features presented below.

Each drive portion 22 in the set of drive portions 20 comprises a drive shaft 26 connected to the fluid motor 14 whereby the drive shaft is adapted to be rotated around an axis of rotation 30 of the drive shaft 26.

Each drive portion 22 in the set of drive portions 20 comprises a set of propulsion members 34 comprising at least one propulsion member 12, preferably two or more propulsion members 12, each propulsion member 12 in the set of propulsion members 34 being rotationally fixed to the drive shaft 26.

Each drive portion 22 in the set of drive portions 20 comprises a fluid actuated control assembly 38 adapted to control a largest distance 54, in a direction perpendicular to the axis of rotation 30 of the drive shaft 26, from the drive shaft 26 to each propulsion member 12 in the set of propulsion members 34.

Moreover, each drive portion 22 in the set of drive portions 20 comprises a fluid pressure gate assembly 72 adapted to allow fluid conducted via the fluid guide conduit 15 to be fed towards the fluid actuated control assembly 38 only if a pressure of fluid exiting the fluid pressure gate assembly 72 is within a predetermined pressure range.

The fluid pressure gate assembly 72 may be implemented in a plurality of different ways in order to ensure that the fluid pressure gate assembly 72 is adapted to allow fluid conducted via the fluid guide conduit 15 to be fed towards the fluid actuated control assembly 38 only if a pressure of fluid exiting the fluid pressure gate assembly 72 is within a predetermined pressure range. For instance, the fluid pressure gate assembly 72 may comprise a single pressure relief valve adapted to allow fluid to pass the single pressure relief valve only if a pressure of fluid exiting the single pressure relief valve is within a predetermined pressure range.

However, FIG. 6b illustrates a preferred implementation of the fluid pressure gate assembly 72 comprising the first pressure relief valve 76 and the second pressure relief valve 82. The arrangement and characteristics of the first pressure relief valve 76 and the second pressure relief valve 82 have been presented above with relation to FIG. 5 and are not repeated here.

Moreover, as indicated in FIG. 6a, each drive portion 22 in the set of drive portions 20 may comprise a pressure booster 86 located between the fluid pressure gate assembly 72 and the fluid actuated control assembly 38. Further, FIG. 6a schematically illustrates the optional feature that, at least one drive portion 22, preferably each drive portion, in the set of drive portions 20 may comprises a fluid actuated control assembly exhaust 102 located downstream the fluid actuated control assembly 38

Irrespective of the embodiment of the tractor 10, the fluid guide conduit 15 (see e.g. each one of the embodiments presented above with relation to any one of FIG. 2, 5 or 6a) may comprise, or may be constituted by, at least one of the following: a coiled tubing or a set of threaded drill strings. As has been indicated above, when the tractor 10 is propelled by means of the propulsion members 12, the tractor 10 may be imparted a torque. The coiled tubing or the set of threaded drill strings may provide a counteracting torque that may mitigate the risk of the tractor being rotated relative to the cylindrical body (not shown in FIG. 2, 5 or 6a) during use.

Turning to FIG. 7a, it is indicated in the non-limiting embodiment illustrated therein that the cylindrical body 60 has a longitudinal extension in a longitudinal cylindrical body direction 108. The tractor 10 is adapted to propel the apparatus 104 in a direction parallel to and/or coaxial with the longitudinal cylindrical body direction 108. In the FIG. 7a example, the apparatus 104 comprises the tractor 10 and a tool 106. However, in other embodiments, the apparatus 104 may comprises a sensor instead of or in addition to the tool 106.

Moreover, as indicated in FIG. 7a, for at least one drive portion 22, preferably each drive portion, in the set of drive portions, when in use, the axis of rotation 30 of the drive shaft 26 and the longitudinal cylindrical body direction 108 form an angle having an absolute value being less than 10°. Preferably, and as indicated in FIG. 7a, the axis of rotation 30 of the drive shaft 26 is parallel to and/or coaxial with the longitudinal cylindrical body direction 108.

Furthermore, FIG. 7a and FIG. 7b illustrate an embodiment in which the set of propulsion members 34 comprises propulsion members 12 each one of which having a rim 64 (see also FIG. 3a for instance) enclosing the drive shaft 26 such that the fluid actuated control assembly 38 is adapted to control an eccentricity of the rim 64 relative to the drive shaft to thereby control the largest distance 54 (see FIG. 3a), in a direction perpendicular to the axis of rotation 30 of the drive shaft 26, from the drive shaft 26 to each propulsion member 12 in the set of propulsion members 34. For the purpose of making it easier to identify the drive shaft 26 and the axis of rotation 30, FIG. 7b does not illustrate the tool 106.

FIG. 7a illustrates the tractor 10 in a condition wherein the propulsion members 12 have a small largest distance 54 (see FIG. 3a), i.e. a small amount of eccentricity such that the propulsion members 12 do not contact the inner surface 58 of the cylindrical body 60. However, in the FIG. 7b condition, each propulsion member 12 has a larger largest distance 54 (see FIG. 3b), i.e. a larger amount of eccentricity such that the propulsion members 12 contact the inner surface 58 of the cylindrical body 60. As such, when the propulsion members 12 are in the condition illustrated in FIG. 7b and the drive shaft 26 is rotated around the axis of rotation 30, the propulsion members 12 will impart the tractor 10 a propulsion force being at least substantially parallel to and/or coaxial with the longitudinal cylindrical body direction 108.

FIG. 7c illustrates the tractor 10 in the same condition as in FIG. 7b although FIG. 7c is a cross-sectional view of the tractor 10. As such, FIG. 7c is a cross-sectional view of for instance, the fluid motor 14.

FIG. 7a also illustrates a second aspect of the present disclosure which relates to a tractor assembly 110 comprising a tractor 10 wherein the fluid guide conduit 15 is rotationally fixed to a portion of the tractor 10. In the FIG. 7a embodiment, the fluid guide conduit 15 is rotationally fixed to a portion of the fluid motor 14 of the tractor 10.

The tractor assembly 110 further comprises a fluid guide conduit rotational lock 112 adapted to prevent a portion of the fluid guide conduit 15 from rotating relative to a portion of the cylindrical body 60. The fluid guide conduit rotational lock 112 may be implemented in a plurality of different ways, for instance by means of a lid (not shown) or the like adapted to be fixed to the cylindrical body 60 to thereby close an end opening thereof and to prevent relative motion between the fluid guide conduit 15 and the lid to thereby prevent a portion of the fluid guide conduit 15 from rotating relative to a portion of the cylindrical body 60. Advantageously, the fluid guide conduit rotational lock 112 may be used for embodiments of the tractor 10 and or the tractor assembly 110 in which the fluid guide conduit 15 comprises, or is constituted by, at least one of the following: a coiled tubing or a set of threaded drill strings. This is since the combination of the fluid guide conduit rotational lock 112 and the coiled tubing and/or set of threaded drill strings may provide an appropriately high torque that may counteract the torque acting on the tractor 10 during propulsion thereof.

Moreover, as has been indicated above, a third aspect of the present disclosure relates to an apparatus 114 comprising a sensor 106 and/or a tool 106 and the tractor 10 according to the first aspect of the present disclosure or a tractor assembly 110 according to the second aspect of the present disclosure.

The sensor 106 or the tool 106 is schematically illustrated in FIG. 7a. As non-limiting examples, the tool may be a jetting nozzle or a fluid activated tool. Moreover, again by means of non-limiting examples only, the sensor 106 could for instance be a sensor for measuring at least one of the following: temperature, fluid flow, torque, pressure and humidity. The sensor 106 and/or tool 106 may be fixedly or releasably connected to the tractor 10. Purely by way of example, the sensor 106 and/or tool 106 may be connected to the tractor 10 by means of a bolt joint (not shown).

A fourth aspect of the present disclosure relates to a cylindrical body assembly 116 comprising a cylindrical body 60 and the tractor 10 according to the first aspect of the present disclosure, the tractor assembly 110 according to according to the second aspect of the present disclosure or the apparatus 114 according to the third aspect of the present disclosure.

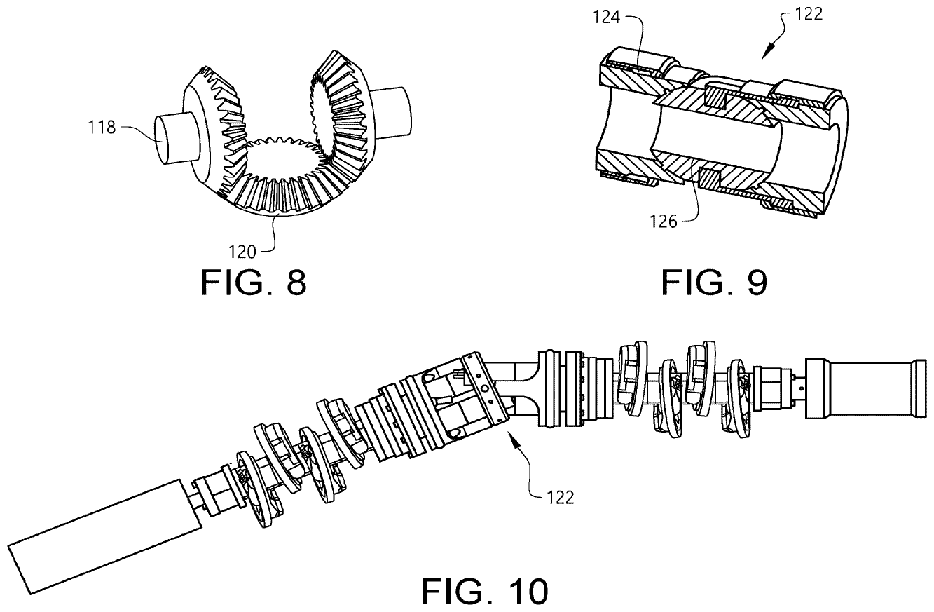

Additionally, FIG. 8 illustrates that contra gears as exemplified therein may be employed on the tractor 10 to keep the torque to a minimum for the whole assembly and prevent any additional torque forces from acting on the apparatus or eliminating turning of the apparatus. The teeth 118 and shaft 120 of the contra gears are illustrated in the drawing.

In another aspect, shown in FIG. 9, one or more knuckle joints 122 may be added as an interface to the tractor 10 to increase flexibility of the apparatus to move through bends and curves. The sections 124, 126 depict front and inner faces of a knuckle joint 122 which may be interfaced to the connecting interfaces of the tractor 10. To this end, FIG. 10 illustrates an embodiment of a tractor 10 in which two drive portions 22, 24 are connected to each other via a knuckle joint 122.

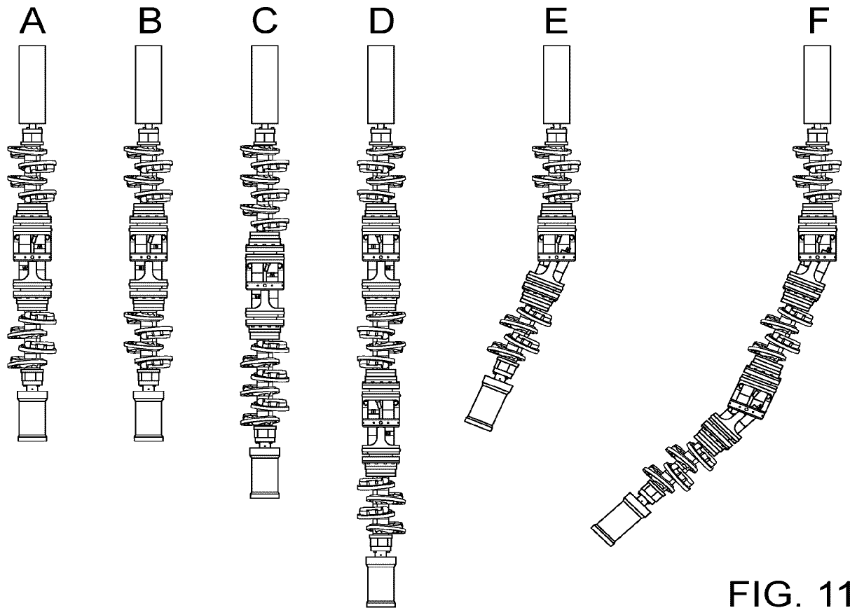

FIG. 11 illustrates how the modular build of the tractor 10 and/or apparatus 104 according to the invention enables different configurations. Configuration A is tractor with two wheel modules with small wheels, suitable for narrow wells or pipelines. Configuration B is similar to A, but here larger wheels are selected. Configuration C has a larger number of wheels than A and B. Configuration D comprises three wheel modules. Configurations E and F comprise a knuckle joint between wheel modules, thus making these configurations suitable for traveling through bends, doglegs and restrictions requiring flexibility of the tractor.

As non-limiting alternatives, the present disclosure may be presented in accordance with any one of the following points. To this end, it should be noted that, by way of example only, the tractor 10 presented above may for instance alternatively be referred to as a modular fluid operated apparatus 10.
Point 1. Modular fluid operated apparatus 10 for propulsion and operations inside a cylindrical body, such as a pipeline, comprising:
   a fluid motor 14,
   an interface module 19 connected to the fluid motor,
   at least one flow module 21, and
   at least one drive module 34,
   where the modules comprise connecting means and are configured to be releasably connected to each other in series.
Point 2. Modular fluid operated apparatus according to point 1, where there are two flow modules 21, one low-flow module 25 and one high-flow module 23.
Point 3. Modular fluid operated apparatus according to point 2, where the low-flow module 23 is connected to the interface module and the high-flow module 23 is connected between the low-flow module and the drive module.
Point 4. Modular fluid operated apparatus according to point 1 or 2, where the drive module comprises a number of wheels providing propulsion of the apparatus.

Point 5. Modular fluid operated apparatus according to one of points 2-4, where the low-flow module is configured to receive a small flow of fluid from the high-flow module and provide pressurized fluid to the drive module 34.
Point 6. Modular fluid operated apparatus according to one of the previous points, where the at least one drive module 34 comprises first and second wheel modules, each drive module comprising a number of wheels, where the wheels 12 in the first wheel module rotate in one direction and the wheels in the second wheel module rotate in a counterrotation with respect to the wheels in the first wheel module.
Point 7. Modular fluid operated apparatus according to one of the previous points, where the interface module comprises swivel means, allowing the fluid motor to rotate relative to the modules of the apparatus.
Point 8. Modular fluid operated apparatus 10 according to any of the previous points, further comprising a tool interface adapted to connect to optional tools, where the tool interface comprises connection means for the tools.
Point 9. Modular fluid operated apparatus 10 according to any of the previous points, comprising a knuckle joint interconnecting two modules.
Point 10. Modular fluid operated apparatus 10 according to any of points 4-8, comprising an eccentric drive configured to move the wheels in a radial direction relative to a central axis of the drive module(s).
Point 11. Modular fluid operated apparatus 10 according to any of points 4-10, comprising emergency means configured to retract the wheels to a position central around a central axis of the drive module(s).

1.-22. (canceled)

23. A tractor for propelling an apparatus inside a cylindrical body, said tractor comprising a fluid motor, said tractor further comprising a fluid guide conduit adapted to guide fluid to said fluid motor, said tractor further comprising a set of drive portions comprising at least one drive portion wherein each drive portion in said set of drive portions comprises:
a drive shaft connected to said fluid motor whereby said drive shaft is adapted to be rotated around an axis of rotation of said drive shaft,
a set of propulsion members comprising at least one propulsion member, preferably two or more propulsion members, each propulsion member in said set of propulsion members being rotationally fixed to said drive shaft;
a fluid actuated control assembly adapted to control a largest distance, in a direction perpendicular to said axis of rotation of said drive shaft, from said drive shaft to each propulsion member in said set of propulsion members, and
a fluid pressure gate assembly adapted to allow fluid conducted via said fluid guide conduit to be fed towards said fluid actuated control assembly only if a pressure of fluid exiting said fluid pressure gate assembly is within a predetermined pressure range.

24. The tractor according to claim 23, wherein said predetermined pressure range is between a low pressure limit and a high pressure limit, said low pressure limit being greater than 0 bar relative pressure, preferably greater than 100 bar relative pressure.

25. The tractor according to claim 24, wherein said high pressure limit is equal to or less than 10 times, preferably equal to or less than 5 times, more preferred equal to or less than 2 times, said low pressure limit.

26. The tractor according to claim 23, wherein said fluid motor comprises a fluid motor fluid inlet and a fluid motor fluid exhaust, said fluid pressure gate assembly being in fluid communication with said fluid motor fluid exhaust such that at least a portion of said fluid pressure gate assembly is adapted to receive fluid from said fluid motor fluid exhaust.

27. The tractor according to claim 23, wherein said fluid pressure gate assembly comprises a first pressure relief valve being adapted to allow fluid passage via said first pressure relief valve (76) to thereby prevent said fluid from being fed towards said fluid actuated control assembly when a fluid pressure acting on said first pressure relief valve is equal to or exceeds a first pressure relief valve threshold pressure, preferably said first pressure relief valve is adapted to allow fluid passage via said first pressure relief valve to the environment ambient of the tractor when said fluid pressure acting on said first pressure relief valve is equal to or exceeds said first pressure relief valve threshold pressure.

28. The tractor according to claim 27, wherein said fluid pressure gate assembly comprises a second pressure relief valve being adapted to allow fluid passage via said second pressure relief valve towards said fluid actuated control assembly when a fluid pressure acting on said second pressure relief valve is equal to or exceeds a second pressure relief valve threshold pressure.

29. The tractor according to claim 23, wherein at least one drive portion, preferably each drive portion, in said set of drive portions comprises a pressure booster located between said fluid pressure gate assembly and said fluid actuated control assembly, as seen in a direction of flow from said fluid pressure gate assembly to said fluid actuated control assembly, said pressure booster comprising a pressure booster inlet and a pressure booster outlet, wherein the pressure booster is such that when in use, fluid exiting said pressure booster outlet has a higher pressure than fluid entering said pressure booster inlet, preferably said pressure booster being adapted to be powered by said fluid entering said pressure booster inlet.

30. The tractor according to claim 23, wherein at least one drive portion, preferably each drive portion, in said set of drive portions comprises a fluid actuated control assembly exhaust located downstream said fluid actuated control assembly, as seen in a direction of flow to said fluid actuated control assembly from said fluid pressure gate assembly, preferably said fluid actuated control assembly exhaust is adapted to discharge fluid to the environment ambient of said tractor.

31. The tractor according to claim 23, wherein, for at least one drive portion, preferably each drive portion, in said set of drive portions, each propulsion member in said set of propulsion members comprises a rim enclosing said drive shaft, preferably each propulsion member in said set of propulsion members comprises a wheel that in turn comprises said rim.

32. The tractor according to claim 31, wherein said fluid actuated control assembly is adapted to control an eccentricity of said rim relative to said drive shaft to thereby control said largest distance, in a direction perpendicular to said axis of rotation of said drive shaft, from said drive shaft to each propulsion member in said set of propulsion members.

33. The tractor according to claim 31, wherein said rim (64) extends in a rim plane, said rim plane forming a rim angle with said axis of rotation of the drive shaft, said rim angle being less than 90°, preferably less than 88°, more preferred less than 85°.

34. The tractor according to claim 23, wherein, for at least one drive portion, preferably each drive portion, in said set of drive portions, each propulsion member in said set of propulsion members comprises a propulsion member contact portion adapted to contact an inner surface of said cylindrical body, said largest distance from said drive shaft to said propulsion member being a distance from said drive shaft (26) to said propulsion member contact portion in said direction perpendicular to said axis of rotation of said drive shaft.

35. The tractor according to claim 23, wherein, for at least one drive portion, preferably each drive portion, in said set of drive portions, each propulsion member in said set of propulsion members is adapted to transfer a force from an inner surface of said cylindrical body to said drive shaft when said largest distance is equal to or above a largest distance threshold.

36. The tractor according to claim 35, wherein, for at least one drive portion, preferably each drive portion, in said set of drive portions, each propulsion member in said set of propulsion members is such that when said drive shaft rotates around said axis of rotation and said propulsion member transfers a force from said inner surface of said cylindrical body to said drive shaft, a propulsion force is imparted on said tractor.

37. The tractor according to claim 35, wherein, for at least one drive portion, preferably each drive portion, in said set of drive portions, each propulsion member in said set of propulsion members is such that when said drive shaft rotates around said axis of rotation and said propulsion member transfers a force from said inner surface of said cylindrical body to said drive shaft, a contact point between said propulsion member and said inner surface of said cylindrical body will vary as said drive shaft rotates around said axis of rotation such that a trajectory of subsequent contact points will form a helical shape on said inner surface of said cylindrical body.

38. The tractor according to claim 23, wherein said cylindrical body has a longitudinal extension in a longitudinal cylindrical body direction, said tractor being adapted to propel said apparatus in a direction parallel to and/or coaxial with said longitudinal cylindrical body direction.

39. The tractor according to claim 38, wherein, for at least one drive portion, preferably each drive portion, in said set of drive portions, when in use, said axis of rotation of said drive shaft and said longitudinal cylindrical body direction form an angle having an absolute value being less than 10°, preferably said axis of rotation of said drive shaft being parallel to and/or coaxial with said longitudinal cylindrical body direction.

40. A tractor assembly comprising a tractor according to claim 23, wherein said fluid guide conduit is rotationally fixed to a portion of said tractor, said tractor assembly further comprising a fluid guide conduit rotational lock adapted to prevent a portion of said fluid guide conduit from rotating relative to a portion of said cylindrical body.

41. An apparatus comprising a sensor and/or a tool and the tractor according claim 23 or a tractor assembly.

42. The apparatus according to claim 41, wherein said tool is adapted to receive fluid from a fluid actuated control assembly exhaust of at least one of said drive portion in said set of drive portions.
